(19) United States
(12) Patent Application Publication
(10) Pub. No.: US 2019/0228607 A1
(43) Pub. Date: Jul. 25, 2019

(54) SHEET RECOGNITION DEVICE AND SHEET RECOGNITION METHOD

(71) Applicant: GLORY LTD., Himeji-shi, Hyogo (JP)

(72) Inventors: Satoshi YOSHIDA, Hyogo (JP); Akira BOGAKI, Hyogo (JP); Masashi TSUNEFUJI, Hyogo (JP); So MURASATO, Hyogo (JP)

(73) Assignee: Glory Ltd., Himeji-shi, Hyogo (JP)

(21) Appl. No.: 16/318,210

(22) PCT Filed: Jul. 10, 2017
(86) PCT No.: PCT/JP2017/025112

§ 371 Date: Jan. 16, 2019

(30) Foreign Application Priority Data
Jul. 21, 2016 (JP) 2016-143442

(51) Int. Cl. G07D 7/164; G07D 7/20; G07D 7/121; G07D 7/128

(52) U.S. Cl. CPC G07D 7/164; G07D 7/128; G07D 7/121; G07D 7/2016

(57) ABSTRACT

The present invention provides a sheet recognition device capable of collecting complete data for a recognition process without fail even when the target medium is a banknote including a transparent portion. The sheet recognition device includes: a ring memory being configured to sequentially store collection data collected by a line sensor and sequentially overwrite an oldest piece of stored collection data with a newest piece of collection data when the data volume exceeds a capacity of the ring memory; and a controller being configured to select a first data path through which the collection data collected by the line sensor is directly output to a recognition processor or a second data path through which the collection data collected by the line sensor is output to the ring memory and the stored data in the ring memory is output to the recognition processor, upon detection of arrival of a sheet by a medium detection sensor or the line sensor, the controller selecting the second data path upon detection of arrival of the sheet by the line sensor and outputting, to the recognition processor, the collection data collected by the line sensor and stored in the ring memory before the detection of arrival of the sheet.

### TECHNICAL FIELD

The present invention relates to sheet recognition devices and sheet recognition methods. The present invention specifically relates to a sheet recognition device and a sheet recognition method which enable collection of data including an image and a thickness used for recognition of a sheet such as a banknote.

### BACKGROUND ART

Conventional sheet recognition devices detect a transported sheet using optical passage detection sensors disposed along a straight line extending in the direction perpendicular to the transport direction. The optical passage detection sensors, however, may not react depending on the transport state of a banknote, failing to collect image data of the sheet.

Patent Literature 1 discloses a medium recognition device comprising a medium transport path along which a medium is transported, and an optical line sensor, which crosses the medium transport path and is configured to obtain image data of the medium. The optical line sensor includes a light emitter and a photodetector having pixels arranged in a line. When the photodetector optically detects a medium and the number of pixels detecting the medium is not smaller than a predetermined number of pixels, the optical line sensor starts to obtain image data. The medium recognition device disclosed in Patent Literature 1, detecting a medium using the optical line sensor and starting to obtain image data when the number of pixels detecting the medium in the photodetector is equal to or greater than the determination value, can therefore accurately obtain image data without fail to activate the optical line sensor.

The paper used for sheets such as banknotes is usually paper made of vegetable fibers. Still, in order to improve the properties such as durability, water resistance, and security, paper made of synthetic fibers or a polymer sheet made of synthetic resin may be used. Banknotes made of polymer sheets are called polymer banknotes. Some sheets have a variety of security characteristics. For example, some polymer banknotes include a clear window (transparent portion) for anti-counterfeiting.

### CITATION LIST

### Patent Literature

Patent Literature 1: JP 4534819 B

### SUMMARY OF INVENTION

### Technical Problem

Appearance of polymer banknotes led to circulation of banknotes including a clear window. Conventional banknote recognition devices, however, may unfortunately fail to obtain image data of a banknote because its optical passage detection sensor cannot detect a clear window as part of a banknote.

The medium recognition device disclosed in Patent Literature 1 can obtain image data of a medium without fail since the optical line sensor starts to obtain the image data when the number of pixels detecting the medium in the optical line sensor is equal to or greater than the determination value. Still, with a small determination value, the optical line sensor may falsely detect a strip of a medium or a foreign material such as dust as a medium, starting to obtain the image data at an undesired timing. Conversely, with a large determination value, the optical line sensor may detect a medium at a delayed time point and thus may start to collect image data at a delayed time point, failing to collect image data of the front edge of the medium. Especially in the case where the medium is a polymer banknote including a clear window at its front edge, the optical line sensor may detect the medium at a delayed time point, failing to collect image data of the entire medium surface. This has led to a demand for a technique to collect image data of the entire medium surface without fail.

In response to the above issue, an object of the present invention is to provide a sheet recognition device and a sheet recognition method which enable collection of complete data for a recognition process without fail even when the target medium is a banknote including a transparent portion.

### Solution to Problem

In order to overcome the issue and achieve the above object, a first aspect of the present invention is directed to a sheet recognition device configured to collect data for recognition of a sheet, the device comprising: a transporter configured to transport the sheet; a medium detection sensor partially disposed in a width direction of a transport path and configured to detect arrival of the transported sheet, the width direction crossing a transport direction of the sheet; a line sensor disposed at a more downstream position of the transport path than the medium detection sensor, having a linear shape extending in the width direction of the transport path, and configured to scan at least part of the transported sheet; a ring memory configured to sequentially store collection data collected by the line sensor and sequentially overwrite an oldest piece of stored collection data with a newest piece of collection data when the stored data volume exceeds a capacity of the ring memory; a recognition processor configured to recognize the sheet; a first data path through which the line sensor directly outputs the collection data to the recognition processor; a second data path through which the line sensor outputs the collection data to the ring memory and the ring memory outputs the stored data to the recognition processor; and a controller configured to select the first data path or the second data path upon detection of arrival of the sheet by the medium detection sensor or the line sensor, the controller selecting the second data path upon detection of arrival of the sheet by the line sensor and causing the ring memory to output, to the recognition processor, the collection data collected by the line sensor and stored in the ring memory before the detection of arrival of the sheet.

In the first aspect of the present invention, the controller may be configured to cause the ring memory to continuously output the collection data collected by the line sensor and stored before the detection of arrival of the sheet and then the collection data collected by the line sensor after the detection of arrival of the sheet to the recognition processor through the second data path.

In the first aspect of the present invention, the controller may be configured to, upon detection of arrival of the sheet by the medium detection sensor, select the second data path and delay the time for the ring memory to start outputting collection data collected by the line sensor later than to after the time set for the case of detection of arrival of the sheet by the line sensor.

In the first aspect of the present invention, the controller may be configured to cause the ring memory to output the collection data collected by the line sensor and stored before the detection of arrival of the sheet to the recognition processor through the second data path, and cause the line sensor to output the collection data collected after the detection of arrival of the sheet to the recognition processor through the first data path.

In the first aspect of the present invention, the line sensor may be an optical line sensor.

In the first aspect of the present invention, the optical line sensor may comprise a light source configured to irradiate the transported sheet with light, and a photodetector configured to receive the light transmitted by the sheet, and the controller may be configured to determine whether or not a detection amount of the sheet is equal to or greater than a threshold based on a transmission image obtained by the optical line sensor.

In the first aspect of the present invention, the line sensor may be a thickness detection sensor.

In the first aspect of the present invention, the controller may be configured to determine a degree of skew of the transported sheet and change the volume of data to be output by the ring memory based on the degree of skew, the data being stored in the ring memory before the detection of arrival of the sheet.

A second aspect of the present invention is directed to a sheet recognition method used to collect data for recognition of a sheet, the method comprising: detecting arrival of the sheet transported, using a medium detection sensor being partially disposed in a width direction of a transport path, the width direction crossing a transport direction of the sheet; scanning at least part of the transported sheet, using a line sensor being disposed at a more downstream position of the transport path than the medium detection sensor and having a linear shape extending in the width direction of the transport path; sequentially storing collection data collected by the line sensor in the scanning into a ring memory and sequentially overwriting an oldest piece of stored collection data with a newest piece of collection data when the stored data volume exceeds a capacity of the ring memory; and selecting, upon detection of arrival of the sheet in the detecting or the scanning, a first data path through which the line sensor directly outputs the collection data to a recognition processor or a second data path through which the line sensor outputs the collection data to the ring memory and the ring memory outputs the stored data to the recognition processor, the method including selecting the second data path upon detection of arrival of the sheet by the line sensor and causing the ring memory to output, to the recognition processor, the collection data collected by the line sensor and stored in the ring memory before the detection of arrival of the sheet.

### Advantageous Effects of Invention

The sheet recognition device and the sheet recognition method according to the present invention enable collection of complete data for a recognition process without fail even when the target medium is a banknote including a transparent portion.

### BRIEF DESCRIPTION OF DRAWINGS

FIG. 1 is a schematic perspective view illustrating the appearance of a banknote handling machine 100 in Embodiment 1.

FIG. 2 includes schematic views illustrating the configuration of a sensor unit 105 in a banknote recognition device of Embodiment 1; FIG. 2(a) is a view of the sensor unit 105 from a side, FIG. 2(b) is a view of the upper part of the sensor unit 105 from the lower side (from the Z-axis negative side), and FIG. 2(c) is a view of the bottom part of the sensor unit 105 from the upper side (from the Z-axis positive side).

FIG. 3 is a schematic view illustrating a method for processing image data obtained by an optical line sensor 20 before banknote detection.

FIG. 4 includes schematic views illustrating the relationship between a banknote detection state and the method for processing image data obtained by the optical line sensor 20; FIG. 4(a) illustrates a case where a banknote 1 enters detection regions of medium detection sensors 12a and 12b normally, FIG. 4(b) illustrates a case where a banknote 1 enters the detection region of the medium detection sensor 12a skewedly, and FIG. 4(c) illustrates a case where a banknote 1 including a clear window 2a enters the detection regions of the medium detection sensors 12a and 12b normally.

FIG. 5 includes schematic views illustrating, in processing a banknote 1 including a clear window 2a, a case where the banknote 1 cannot be detected by the medium detection sensors 12a and 12b; FIG. 5(a) illustrates a state before the banknote 1 enters any detection region, and FIG. 5(b) illustrates a state where the banknote 1 is detected by the optical line sensor 20.

FIG. 6 is a schematic plan view of an exemplary banknote 1 to which the same process as in FIG. 5 is applied.

FIG. 7 includes schematic views illustrating, in processing a banknote 1 including a clear window 2a, a case where the banknote 1 is detected by the medium detection sensors 12a and 12b and processed through a first data path; FIG. 7(a) illustrates a state before the banknote 1 enters any detection region, FIG. 7(b) illustrates a state where the banknote 1 is detected by the medium detection sensor 12b, and FIG. 7(c) illustrates a state where the banknote 1 is detected by the optical line sensor 20.

FIG. 8 is a schematic plan view illustrating an exemplary banknote 1 to which the same process as in FIG. 7 is applied.

FIG. 9 includes schematic views illustrating, in processing a banknote 1 including a clear window 2a, a case where the banknote 1 is detected by the medium detection sensors 12a and 12b and processed through a second data path; FIG. 9(a) illustrates a state before the banknote 1 enters any detection region, FIG. 9(b) illustrates a state where the banknote 1 is detected by the medium detection sensors 12a and 12b, and FIG. 9(c) illustrates a state where the banknote 1 is detected by the optical line sensor 20.

FIG. 10 is a flowchart of an exemplary process executed by a controller in Embodiment 1.

FIG. 11 is a functional block diagram of an exemplary processing system to execute a medium entry detection function according to Embodiment 1.

FIG. 12 is a schematic cross-sectional view of a thickness detection sensor in Embodiment 1 from a side. FIG. 13 is a schematic perspective view illustrating the appearance of a detection block 73 side of the thickness detection sensor in Embodiment 1.

FIG. 14 is a schematic perspective view illustrating the appearance of the whole thickness detection sensor in Embodiment 1.

### DESCRIPTION OF EMBODIMENTS

An embodiment of the sheet recognition device and the sheet recognition method according to the present invention is described in detail below with reference to the drawings. The sheet recognition device and the sheet recognition method according to the present invention can be used to recognize a variety of types of sheets, including banknotes (printed money), gift vouchers, checks, documents of value, and card-like media. In the following embodiment, a banknote recognition device and a sheet recognition method which recognize banknotes are described as an exemplary sheet recognition device and an exemplary sheet recognition method.

### Embodiment 1

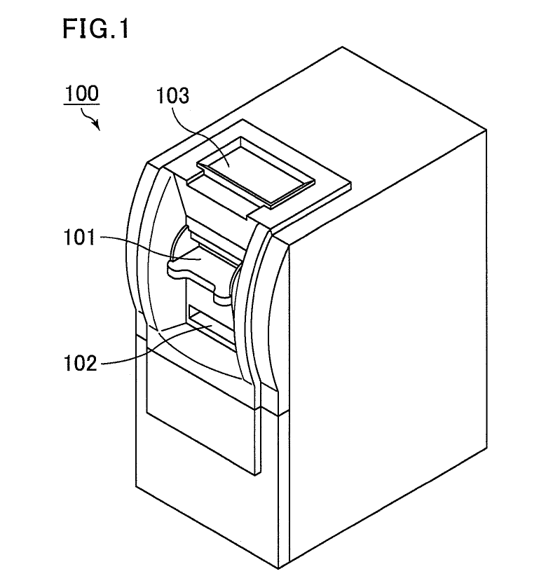

A banknote recognition device of Embodiment 1 is disposed inside a banknote handling machine 100 illustrated in FIG. 1, and is configured to collect data to recognize a banknote. The banknote handling machine 100 is used to deposit and dispense banknotes, and includes a banknote inlet 101, a banknote outlet 102, an operation/display unit 103, and a banknote recognition device (not illustrated).

The operation/display unit 103 is an input device for inputting various pieces of information required to use the banknote handling machine 100, and is also an output device for outputting various pieces of information on the display.

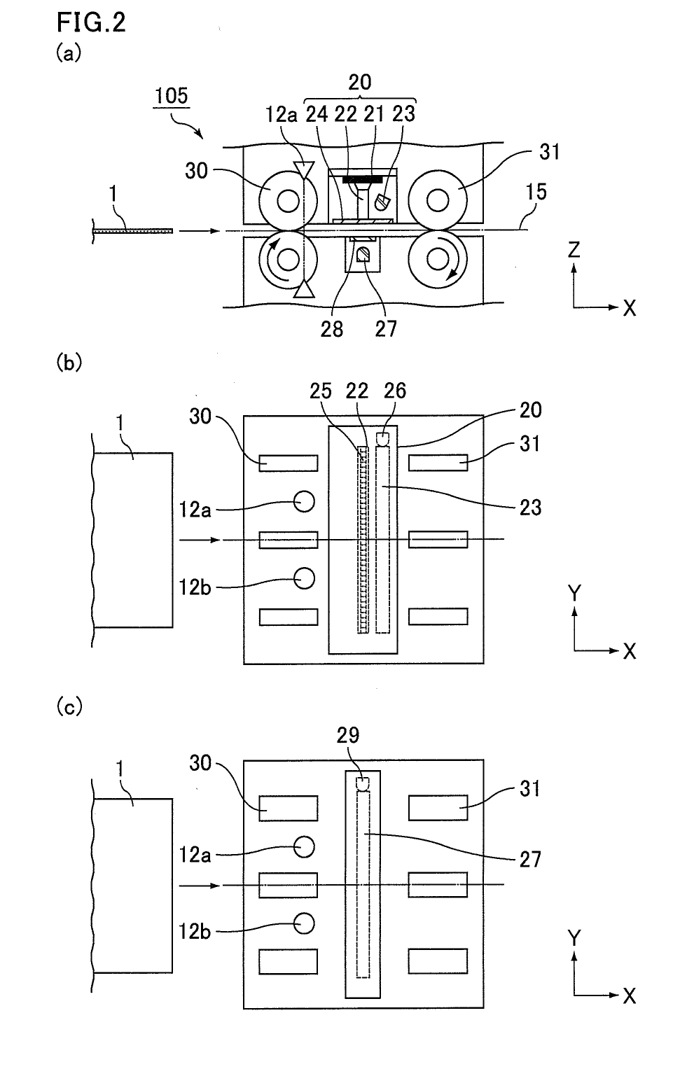

The banknote recognition device of the present embodiment includes, as illustrated in FIG. 2, a sensor unit 105 including rollers 30 and 31, medium detection sensors (timing sensors) 12a and 12b, and an optical line sensor 20.

The rollers 30 and 31 are driven by a drive unit such as a motor, which is not illustrated, and constitute a transporter configured to transport a banknote 1. Each of the rollers 30 and 31 is rotated by the drive unit, so that the banknote 1 is transported along the transport path 15. Specifically, the banknote 1 having entered the sensor unit 105 from the left side is transported inside the sensor unit 105 in the X-axis positive direction, and is ejected from the right side of the sensor unit 105. The transport member is not limited to rollers, and may be belts, for example.

The medium detection sensors 12a and 12b are configured to detect arrival of the banknote 1 sequentially transported into the sensor unit 105, and generate a banknote entry detection signal to determine the timing to start detection of the banknote 1 in the sensor unit 105. The medium detection sensors 12a and 12b used are typically light-reflective or light-transmissive optical sensors, but may be sensors mechanically detecting passage of a banknote 1. Two medium detection sensors, namely the medium detection sensors 12a and 12b, are disposed side by side in the width direction (Y-axis direction) of the transport path 15, which is the direction perpendicular to the transport direction of the banknote 1. Yet, the number of the medium detection sensors may be one or three or more. The medium detection sensors 12a and 12b are partially disposed in the width direction of the transport path 15. In FIG. 2, the medium detection sensors 12a and 12b are disposed near the rollers 30 so that the machine is suitable for the case of transporting the banknote 1 in the X-axis position direction. The medium detection sensors 12a and 12b may be disposed near the rollers 31 as well, so that the machine is also suitable for the case of transporting the banknote 1 in the X-axis negative direction.

At the more downstream side (X-axis positive direction side) of the transport path 15 than the medium detection sensors 12a and 12b is disposed an optical line sensor 20. The optical line sensor 20 is preferably a contact image sensor (CIS). The optical line sensor 20 includes, as shown in FIG. 2(a), an image sensor 21 such as a CCD image sensor or a CMOS image sensor, a rod lens array (array of transparent tubular condenser lenses) 22 for leading light from the banknote 1 passing therebelow to the image sensor 21, and a light guide 23 extending along the rod lens array 22. The bottom face of the sensor case is made of a transparent material and functions as a measurement window 24. Light from the light guide 23 travels through the measurement window 24 and is reflected on the banknote 1. The reflected light travels through the measurement window 24 and the rod lens array 22 and is received by the image sensor 21.

The optical line sensor 20 has, as shown in FIG. 2(b), a linear shape and crosses the transport path 15 in the width direction (Y-axis direction). The Y-axis direction length of the optical line sensor 20 is designed longer than the width of the transport path 15 such that the optical line sensor 20 can scan the entire banknote 1 transported. The optical line sensor 20 includes a plurality of photodetectors (pixels) 25 such as photo diodes, which is disposed in the Y-axis direction and constitutes the image sensor 21. The light guide 23 and the rod lens array 22 are disposed at positions suited for the image sensor 21. As shown in FIG. 2(b), a light source 26 for reflection, such as LEDs, is disposed at one side of the light guide 23. Light from the light source 26 for reflection is incident on the light guide 23. The light guide 23 is configured to guide incident light in the Z-axis negative direction while guiding the incident light in the Y-axis negative direction so as to emit light toward the banknote 1. The light source 26 for reflection is composed of members such as LEDs capable of emitting light rays in different wavelength ranges, for example, and can emit light in a selected wavelength range (e.g., green light or infrared light).

As shown in FIG. 2(a) and FIG. 2(c), below the optical line sensor 20 are provided one light guide 27 and a light source 29 for transmission, such as LEDs, at one side of the light guide 27. Light from the light source 29 for transmission is incident on the light guide 27, and the light guide 27 is configured to guide incident light in the Z-axis positive direction while guiding the incident light in the Y-axis negative direction so as to emit light toward the banknote 1. The top face of the case housing the light guide 27 is made of a transparent material and functions as an irradiation window 28. Light is emitted from the light source 29 for transmission toward the banknote 1 through the light guide 27 and the irradiation window 28. The light having passed through the banknote 1 is then received by the image sensor 21 through the measurement window 24 and the rod lens array 22. The light source 29 for transmission is composed of members such as LEDs capable of emitting light rays in different wavelength ranges, for example, and can emit light in a selected wavelength range (e.g., green light or infrared light).

The light guide 23 for guiding light from the light source 26 for reflection and emitting the light toward the banknote 1, the light guide 27 for guiding light from the light source 29 for transmission and emitting the light toward the banknote 1, and the image sensor 21 for receiving light reflected on the banknote 1 and light transmitted through the banknote 1 are disposed as shown in FIG. 2(b) and FIG. 2(c) such that the optical line sensor 20 can obtain a reflection image and a transmission image of the entire surface of the banknote 1 transported. The optical line sensor 20 scans the transported banknote 1 in the transport direction to capture an image of the entire surface of the banknote 1. Specifically, the optical line sensor 20 captures an image of the entire banknote 1 by successively capturing images of the entire linear imaging target regions of the banknote 1 in the Y-axis direction.

The banknote recognition device of the present embodiment further includes a ring memory (circulating buffer memory), a recognition processor, a storage device, and a controller. The ring memory sequentially stores image data of the banknote 1 obtained by the optical line sensor 20. The ring memory capacity is smaller than image data of one captured image of the banknote 1. When the volume of stored data exceeds the capacity of the ring memory, the ring memory sequentially overwrites the oldest piece of stored image data with the newest piece of image data.

The recognition processor recognizes the banknote 1 using the collected image data of the banknote 1. The recognition may be any process such as recognition of the type (denomination) of the banknote 1, authentication of the banknote 1, determination of the fitness of the banknote 1, or reading of symbols, including numbers and characters printed on the banknote 1. The recognition performed by the recognition processor includes appropriately checking the collected image data of the banknote 1 against the reference image data stored in the storage device in advance.

The controller selects the path through which the image data of the banknote 1 obtained by the optical line sensor 20 is output to the recognition processor. When the first data path is selected, the image data of the banknote 1 is directly output from the optical line sensor 20 to the recognition processor. When the second data path is selected, the image data of the banknote 1 is output from the optical line sensor 20 to the ring memory, and then the stored data in the ring memory is output to the recognition processor. The expression the data is “directly output to the recognition processor” means that the data is output to the recognition processor without being stored in the ring memory. While the data is output from the optical line sensor 20 to the recognition processor, the data may be subjected to various data processes such as amplification, A/D conversion (digitalization), imaging, and image correction.

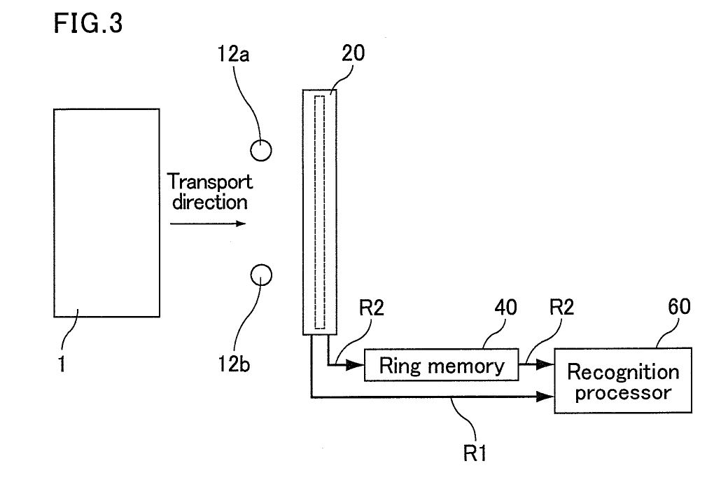

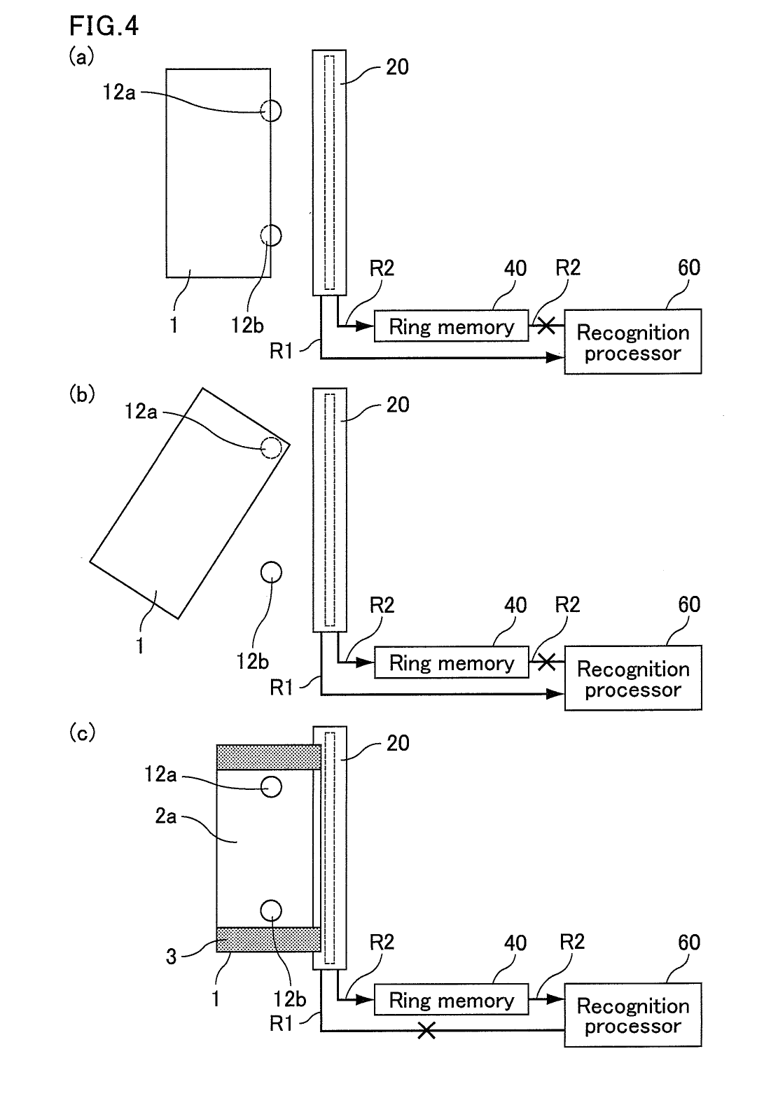

How to collect and output the image data of the banknote 1 in the present embodiment is described in detail below with reference to FIGS. 3 and 4. As illustrated in FIG. 3, the optical line sensor 20 starts to capture images before the medium detection sensors 12a and 12b detect arrival of the banknote 1. The ring memory 40 constantly reads out the image data obtained by the optical line sensor 20 and stores the data. The optical line sensor 20 may start image capturing when, for example, the banknote handling machine 100 starts to transport the banknote 1 from the banknote inlet 101. The image data obtained by the optical line sensor 20 may be of any type, such as a transmission image obtained using infrared light (transmitted infrared image data), a transmission image obtained using green light, a reflection image obtained using infrared light, a reflection image obtained using green light, a reflection image obtained using purple light, or a reflection image obtained using far-infrared light.

When the controller selects a first data path R1, the banknote recognition device of the present embodiment directly outputs the image data of the banknote 1 obtained by the optical line sensor 20 to the recognition processor 60. When the controller selects a second data path R2, the banknote recognition device outputs the image data of the banknote 1 stored in the ring memory 40 to the recognition processor 60. The banknote recognition device of the present embodiment detects arrival of the banknote 1 using at least one selected from the two medium detection sensors 12a and 12b and the optical line sensor 20. The controller then selects the first data path R1 or the second data path R2 depending on which sensor detected the arrival of the banknote 1.

As illustrated in FIG. 4(a), when the banknote 1 enters the detection regions normally and at least one selected from the medium detection sensors 12a and 12b detects the arrival of the banknote 1 normally, the controller can select the first data path R1 to start a first process where the image data of the banknote 1 obtained by the optical line sensor 20 is directly output to the recognition processor 60 without the image data of the banknote 1 stored in the ring memory 40 being output. While the image data of the banknote 1 obtained by the optical line sensor 20 is directly output to the recognition processor 60, the operation of the ring memory 40 may be temporarily suspended to reduce power consumption. In the first process, the image data starts to be output to the recognition processor 60 at an early timing, which enables early completion of the data process (recognition) in the post-stage circuit.

As illustrated in FIG. 4(b), even when the banknote 1 enters the detection regions skewedly, the medium detection sensor 12a or 12b can detect the banknote 1 before the front edge of the banknote 1 enters the imaging region of the optical line sensor 20. The controller therefore can select the first data path R1 to start the first process where the image data of the banknote 1 obtained by the optical line sensor 20 is directly output to the recognition processor 60.

In contrast, as illustrated in FIG. 4(c), when the banknote 1 including a large clear window 2a in its center portion enters the detection regions of the medium detection sensors 12a and 12b normally, the clear window 2a passes by the detection regions, and thus the medium detection sensors 12a and 12b do not determine that they have detected arrival of the banknote 1, so that the first process does not start. When the front edge of the banknote 1 enters the imaging region of the optical line sensor 20 and the optical line sensor 20 determines that the detection amount of the banknote 1 is equal to or greater than the threshold, the controller selects the second data path R2 to start a second process where the image data of the banknote 1 stored in the ring memory 40 is output to the recognition processor 60. The threshold set for the detection amount of the banknote 1 can prevent the controller from starting to collect data at an undesired timing due to a strip of the banknote 1 or a foreign material such as dust. Also, since the controller outputs the image data of the banknote 1 stored in the ring memory 40 before its determination to start the second process to the recognition processor 60, the image data of the entire surface of the banknote 1 can be collected in the second process even with the threshold set for the detection amount of the banknote 1. The controller preferably determines whether or not the detection amount of the banknote 1 is equal to or greater than the threshold, using the transmission image obtained by the optical line sensor 20.

The volume of data output from the ring memory 40 in the second process is not particularly limited. All or part of the data stored in the ring memory 40 before the determination to start the second process may be output. For example, the controller may determine the degree of skew of the banknote 1 transported, and change the volume of previously stored data to be read out from the ring memory 40, depending on the degree of skew. This can appropriately reduce the image data size of each image of the banknote 1 to be collected. Here, the data stored in the ring memory 40 is preferably read out from oldest to newest.

The image data of the banknote 1 obtained by the optical line sensor 20 after the determination to start the second process may be stored in the ring memory 40 through the second data path R2 and then output to the recognition processor 60, or may be output directly from the optical line sensor 20 to the recognition processor 60 through the first data path R1 without being temporarily stored in the ring memory 40. In the former case, the ring memory 40 sequentially stores image data of the banknote 1 continuously after the determination to start the second process, and the controller reads out the image data stored before the determination to start the second process and then the image data of the banknote 1 collected after the determination to start the second process, from the ring memory 40 through the second data path R2. In the latter case, the controller reads out the image data of the banknote 1 stored before the determination to start the second process from the ring memory 40 through the second data path R2 and obtains the image data of the banknote 1 collected after the determination to start the second process from the optical line sensor 20 through the first data path R1 without the ring memory 40 being involved. In this case, the controller preferably combines the image data of the banknote 1 obtained from the ring memory 40 through the second data path R2 and the image data of the banknote 1 directly obtained from the optical line sensor 20 through the first data path R1.

The banknote 1 used in the present embodiment may be of any type. The material used for the banknote 1 may be paper made of vegetable fibers, synthetic paper made of synthetic fibers, or a polymer sheet made of synthetic resin.

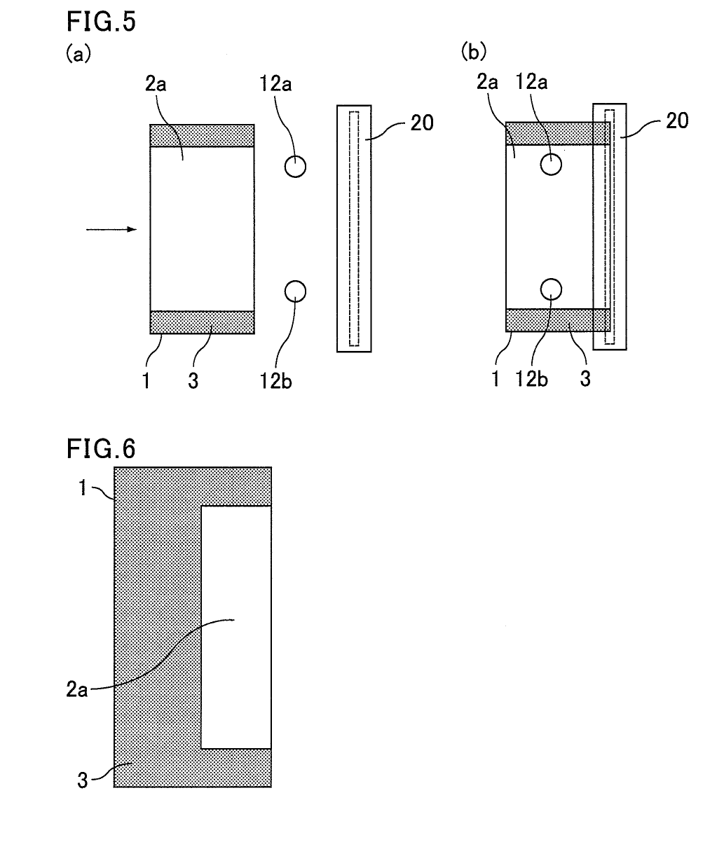

The banknote recognition device of the present embodiment is particularly useful to collect data of the banknote 1 including the clear window (transparent portion) 2a, and can collect data of various clear windows 2a without fail. How to process the banknote 1 including the clear window 2a is described with reference to FIGS. 5 to 9. The banknote 1 illustrated in FIG. 5 includes at its center the clear window 2a having a belt shape, as the transparent portion capable of transmitting light, from one edge to the other edge in the short edge direction, and includes an opaque portion 3 on each side in the long edge direction of the banknote 1 from one edge to the other edge in the short edge direction. The clear window 2a is preferably made of a synthetic resin, and thus the banknote 1 is preferably made of a polymer sheet. The banknote 1 may also be a banknote (hybrid banknote) whose clear window 2a is a polymer sheet and whose opaque portions 3 are paper made of vegetable fibers or synthetic fibers.

The banknote recognition device of the present embodiment can collect the complete image data of the entire surface of the banknote 1 without fail even when the clear window 2a first enters the imaging region of the optical line sensor 20 since the data up to entry of the opaque portions 3 is stored in the ring memory 40. In the recognition of the banknote 1, data collected using a light source enabling capturing of an image of a clear window 2a, such as a light source for reflection, is usually used. The image data of the entire surface of the banknote 1 therefore includes image data of the clear window 2a as well. Meanwhile, the medium detection sensors 12a and 12b and the optical line sensor 20 preferably detect the banknote 1 using only data collected using a light source for transmission. However, data of the clear window 2a collected using a light source for transmission cannot be used in detection of the banknote 1 because it is saturated as in the case where the banknote 1 is absent.

As illustrated in FIG. 5, when the clear window 2a passes by both the detection region of the medium detection sensor 12a and the detection region of the medium detection sensor 12b in transport of the banknote 1, the medium detection sensors 12a and 12b cannot detect the banknote 1. The arrival of the banknote 1 in this case is detected by the optical line sensor 20 at the timing illustrated in FIG. 5(b). Here, the image data of the banknote 1 is output from the ring memory 40 to the recognition processor 60 through the second data path R2. The same process can be performed also in the case where the banknote 1 does not include the clear window 2a from one edge to the other edge in the short edge direction. For example, as illustrated in FIG. 6, the same process is preferably applied to the banknote 1 including the quadrilateral clear window 2a on the front edge side thereof (the forward side in the transport direction).

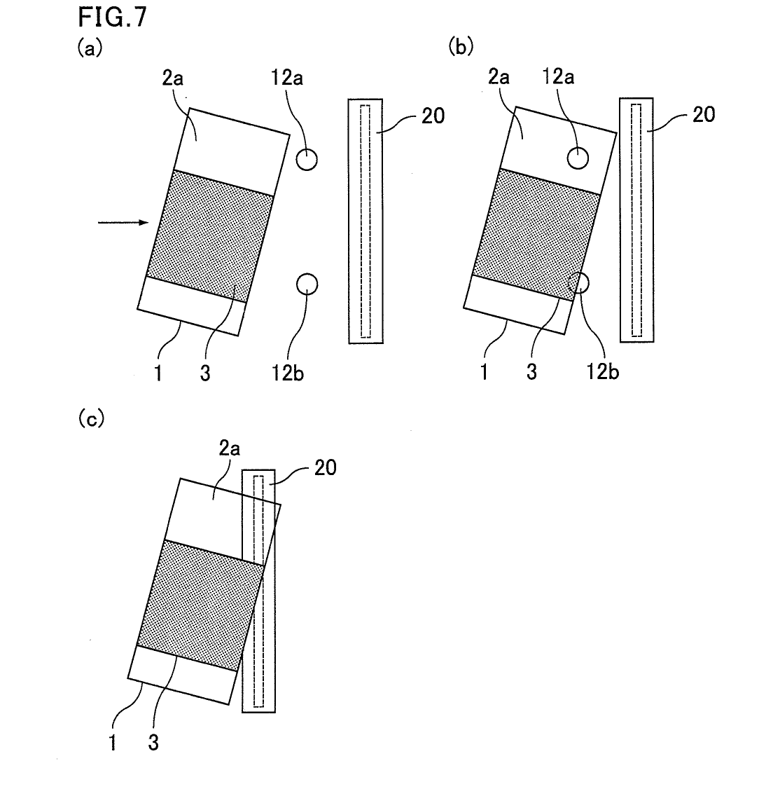

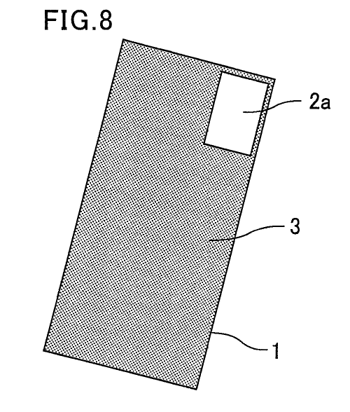

The banknote 1 illustrated in FIG. 7 includes the opaque portion 3 at its center and the clear window 2a having a belt shape on each side in the long edge direction from one edge to the other edge in the short edge direction. As illustrated in FIG. 7, when the clear window 2a passes by only the detection region of the medium detection sensor 12a or the detection region of the medium detection sensor 12b in transport of the banknote 1, the medium detection sensor 12a or 12b detects arrival of the banknote 1 at the timing illustrated in FIG. 7(b). In this case, the image data of the banknote 1 is directly output from the optical line sensor 20 to the recognition processor 60 through the first data path R1 without the ring memory 40 being involved. The same process can be performed also in the case where the banknote 1 does not include the clear window 2a from one edge to the other edge in the short edge direction. For example, as illustrated in FIG. 8, the same process is preferably applied to the banknote 1 including the quadrilateral clear window 2a on the front edge side thereof (the forward side in the transport direction).

In a system in which arrival of the banknote 1 as illustrated in FIG. 7 is supposed to be detected by the optical line sensor 20 alone without the medium detection sensors 12a and 12b, arrival of the banknote 1 transported skewedly with the clear window 2a side moving ahead of the other portions will be detected at the timing illustrated in FIG. 7(c). In this case, the clear window 2a side is moving ahead of the other portions excessively, and the banknote recognition device may fail to collect the complete image data of the entire surface of the banknote 1 even when the data is output from the ring memory 40 to the recognition processor 60 through the second data path R2.

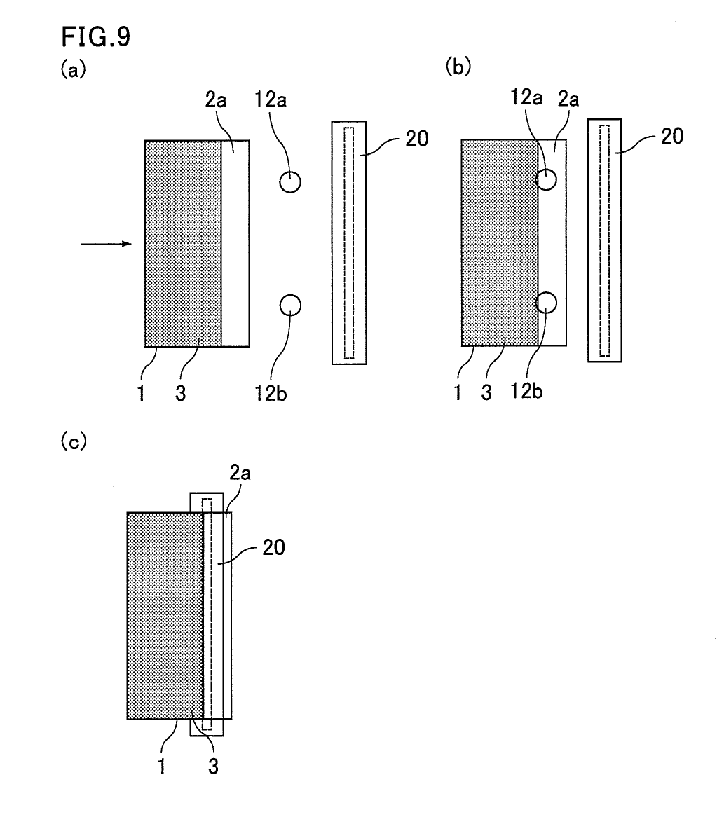

The banknote 1 illustrated in FIG. 9 includes the clear window 2a at the entire front edge thereof (the forward side in the transport direction). As illustrated in FIG. 9, the clear window 2a passes by both the detection region of the medium detection sensor 12a and the detection region of the medium detection sensor 12b in transport of the banknote 1, and the arrival of the banknote 1 is detected by the medium detection sensors 12a and 12b at the timing illustrated in FIG. 9(b). In this case, the image data of the banknote 1 is output from the ring memory 40 to the recognition processor 60 through the second data path R2.

In a system in which arrival of the banknote 1 as illustrated in FIG. 9 is supposed to be detected by the optical line sensor 20 alone without the medium detection sensors 12a and 12b, arrival of the banknote 1 will be detected at the timing illustrated in FIG. 9(c). In this case, the clear window 2a side is moving ahead of the other portions excessively, and the banknote recognition device may fail to collect the complete image data of the entire surface of the banknote 1 even when the data is output from the ring memory 40 to the recognition processor 60 through the second data path R2.

In the examples illustrated in FIG. 4(a), FIG. 4(b), and FIG. 7(b), when at least one selected from the medium detection sensors 12a and 12b detects arrival of the banknote 1, the controller selects the first data path R1 not involving the ring memory 40. When the medium detection sensors 12a and 12b detect the arrival of the banknote 1 as illustrated in FIG. 9(b), the controller may select the second data path R2 involving the ring memory 40. This means that a system may be used in which the controller selects the second data path R2 not only when arrival of the banknote 1 is detected by the optical line sensor 20 but also when arrival of the banknote 1 is detected by the medium detection sensors 12a and 12b. In such a system, when arrival of the banknote 1 is detected by the medium detection sensors 12a and 12b, the controller preferably delays the time for the ring memory 40 start outputting image data to after the time set for the case of detection of arrival of the banknote 1 by the optical line sensor 20. In other words, when arrival of the banknote 1 is detected by the medium detection sensors 12a and 12b, typically, the banknote 1 is at a more backward position than when arrival of the banknote 1 is detected by the optical line sensor 20. Hence, the time interval between the timing of collecting the image data and the timing of detecting arrival of the banknote 1 is preferably further shortened.

As described above with reference to FIGS. 5 to 9, the banknote recognition device of the present embodiment overcomes the problem arising from insufficient detection using the medium detection sensors 12a and 12b alone and the problem arising from insufficient detection using the optical line sensor 20 alone, and is therefore capable of collecting data of various media.

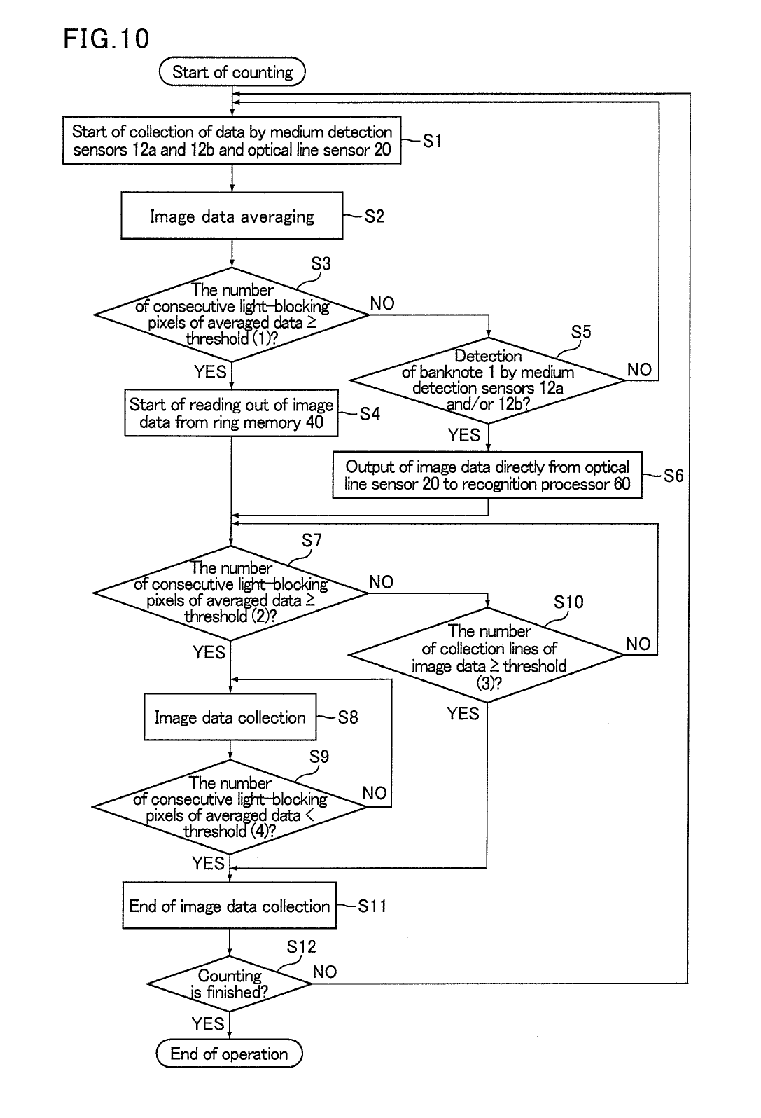

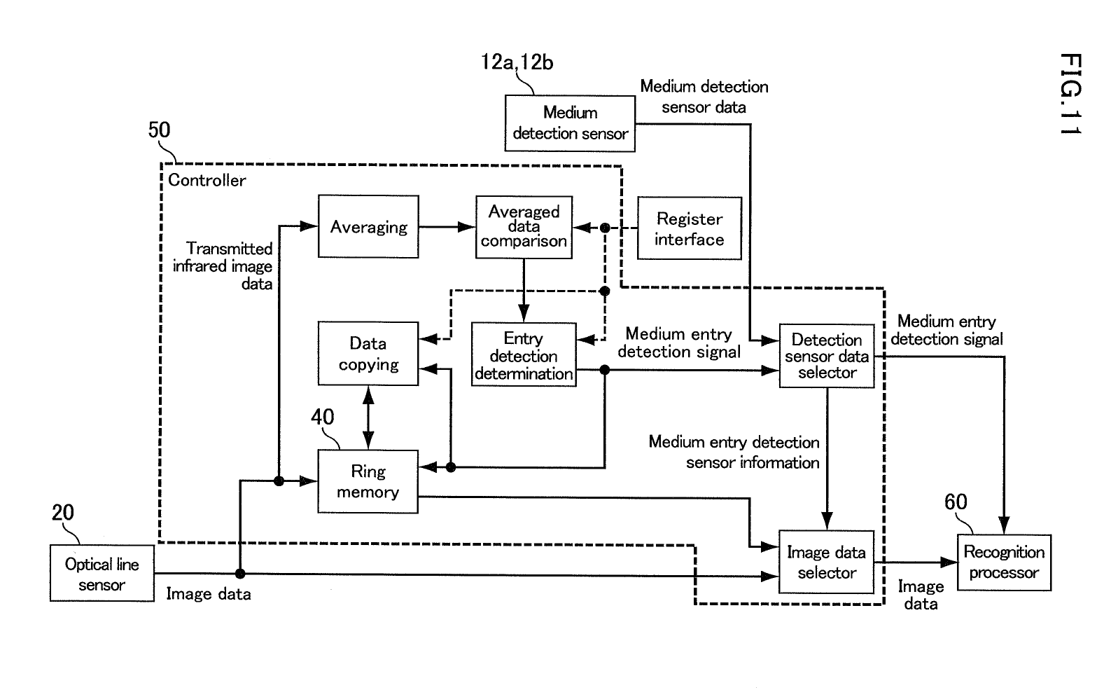

An exemplary flow of the process executed by the controller in the present embodiment is described with reference to FIG. 10. As illustrated in FIG. 10, when the banknote recognition device starts to count the number of banknotes 1, the medium detection sensors 12a and 12b and the optical line sensor 20 start to collect data (step S1). Any image data collected by the optical line sensor 20 and used to detect the banknote 1 is averaged to simplify calculation (step S2). For example, in the case of transmission infrared image data having a resolution of 200×33.4 dpi, the values of six pixels in the main scanning direction are averaged, so that the average data having a resolution of 33.3×33.4 dpi is formed.

Whether the number of consecutive light-blocking pixels in the formed average data is equal to or greater than a threshold (1) is determined (step S3). The threshold (1) is set for determination of whether or not collection of image data is to be started. When the number of consecutive light-blocking pixels in the average data is equal to or greater than the threshold (1), the second process is started, and image data is read out from the ring memory 40 (step S4). When the number of consecutive light-blocking pixels is smaller than the threshold (1) in the average data, whether or not at least one selected from the medium detection sensors 12a and 12b detects the banknote 1 is determined (step S5). When at least one selected from the medium detection sensors 12a and 12b detects the banknote 1, the first process is started, and image data obtained by the optical line sensor 20 is directly output to the recognition processor 60 (step S6). When neither the medium detection sensor 12a nor the medium detection sensor 12b detects the banknote 1, the process returns to the step S1 so that the process is repeated from the beginning.

After the second process is started in the step S4 or the first process is started in the step S6, whether the number of light-blocking pixels is equal to or greater than a threshold (2) is constantly determined using the average data (step S7). The threshold (2) is set for determination of whether or not collection of image data is to be continued. When the number of light-blocking pixels in the average data is equal to or greater than the threshold (2), collection of image data of the banknote 1, which is the imaging target, is continued (step S8). The process is followed by determination of whether or not the number of light-blocking pixels is equal to or greater than a threshold (4) using the average data (step S9). When the number of light-blocking pixels in the average data is smaller than the threshold (2), whether or not the number of collection lines of image data is equal to or greater than a threshold (3) (step S10). The number of collection lines of image data corresponds to the length of the banknote 1 in the transport direction in the image data. When the number of collection lines of image data is determined to be smaller than the threshold (3) in the step S10, collection of image data of the banknote 1, which is the imaging target, is continued.

When the number of collection lines of image data is determined to be equal to or greater than the threshold (3) in the step S10, or when the number of light-blocking pixels is determined to be smaller than the threshold (4) in the step S9, collection of image data of the banknote 1, which is the imaging target, is stopped (step S11).

Whether or not the counting of the banknotes 1 in the banknote recognition device is finished is determined (step S12). When the counting of the banknotes 1 is not finished, the process returns to step S1 and is repeated from the beginning so that the data of the next banknote 1 can be collected. When the counting of the banknotes 1 is finished, the process is finished. The ring memory 40 stores a certain volume of the latest image data from the start of the counting to the end of the counting.

An exemplary processing system to execute the medium entry detection function in the present embodiment is described based on the functional block diagram shown in FIG. 11. The same points as those described for the process illustrated in FIG. 10 will not be elaborated upon here.

As illustrated in FIG. 11, the image data collected by the optical line sensor 20 is stored in the ring memory 40, while the image data (transmission infrared image data) collected by the optical line sensor 20 and used to detect the banknote 1 is averaged by a controller 50. The average data obtained by the averaging is compared with the threshold information obtained from the register interface (averaged data comparison), so that whether or not entry of the banknote 1 is detected is determined. When entry of the banknote 1 is detected, a medium entry detection signal is emitted to a detection sensor data selector. To the detection sensor data selector is input a medium detection sensor data also when at least one selected from the medium detection sensors 12a and 12b detects entry of the banknote 1. As described above, when the medium detection sensor 12a or 12b or the optical line sensor 20 detects entry of the banknote 1, a signal is input to the detection sensor data selector and the detection sensor data selector outputs the medium entry detection sensor information to the image data selector. The image data selector, based on the medium entry detection sensor information, selects which data to read out, the image data collected by the optical line sensor 20 or the data stored in the ring memory 40. The image data read out by the image data selector is output to the recognition processor 60. Part of the image data stored in the ring memory 40 may be copied and temporarily stored as necessary.

In the present embodiment, the sensor unit 105 may include an additional sensor as well as the medium detection sensors 12a and 12b and the optical line sensor 20 as appropriate. The additional sensor may be, for example, a magnetic sensor configured to determine the magnetic properties of the banknote 1, a thickness detection sensor configured to measure the thickness of the banknote 1, or a fluorescence sensor configured to irradiate the banknote 1 with ultraviolet light to determine the fluorescent ink portion on the banknote 1. The data obtained by the additional sensor is also used in recognition of the banknote 1 by the recognition processor 60.

The magnetic sensor detects magnetic information such as magnetic ink printed on the banknote 1. The magnetic sensor preferably includes a plurality of magnetic detectors (magnetic heads) in a line. The magnetic detectors are preferably those outputting a change in magnetic flux density as a signal fluctuation (differential magnetic sensors). Specific examples thereof include magnetoresistors (MR elements), coils, fluxgate sensors (FG elements), and magneto-impedance sensors (MI elements). The magnetoresistors (MR elements) may be anisotropic magnetoresistors (AMR elements), giant magnetoresistors (GMR elements), or tunnel magnetoresistors (TMR elements), for example. The magnetic detectors may also be one outputting the magnitude (absolute value) of the magnetic flux density, such as a hall effect sensor.

The thickness detection sensor detects the thickness of the banknote 1 transported along the transport path 15. The thickness detection sensor detects damage on the banknote 1, such as a defect, including a tear and a hole, a fold, or attached tape, and detects overlapping transported banknotes 1. Examples of the thickness detection sensor include those utilizing a sensor to detect the amount of displacement during passage of the banknote 1 between rollers facing each other across the transport path 15.

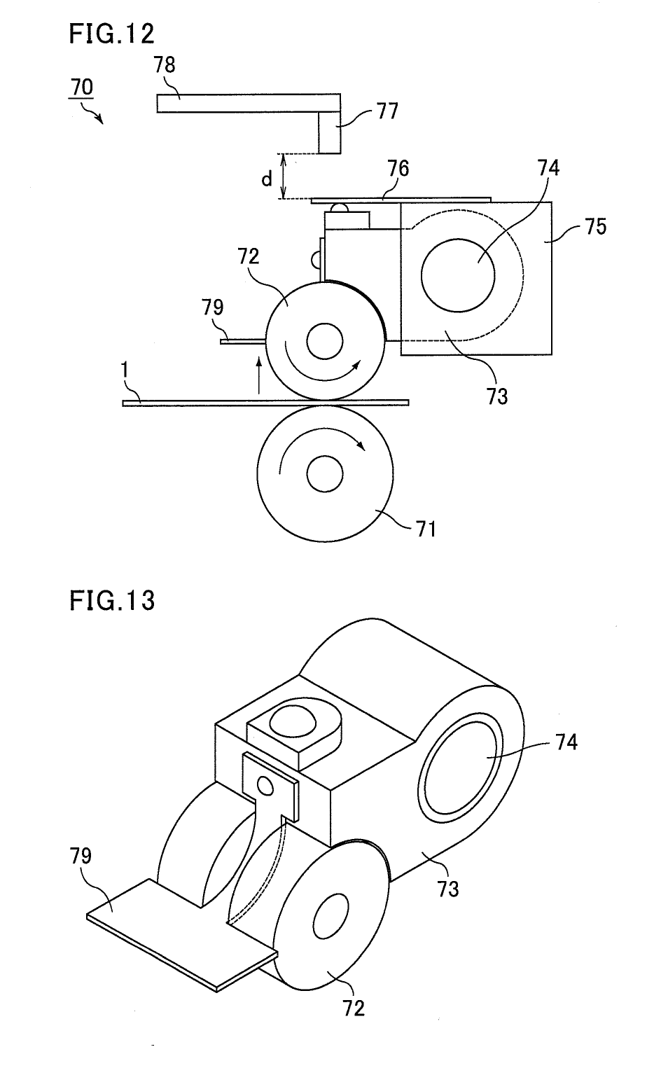

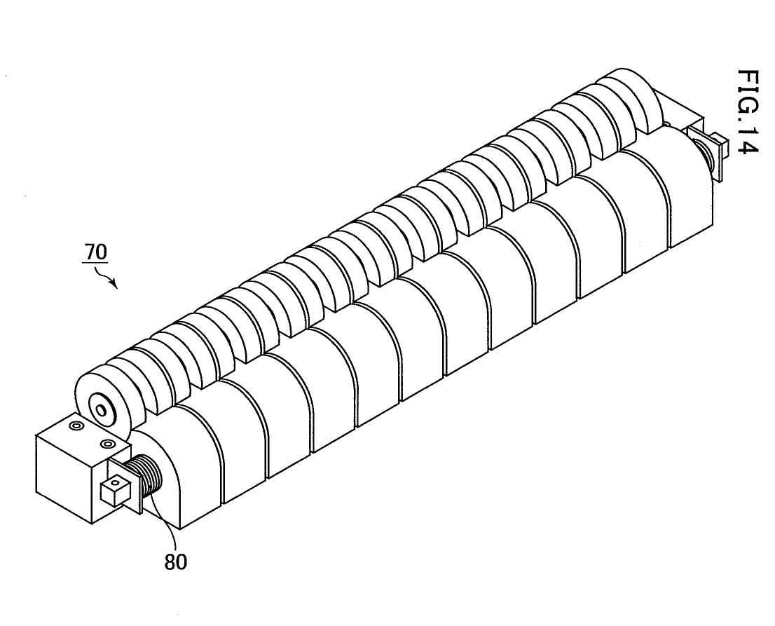

An exemplary configuration of the thickness detection sensor is described in detail with reference to FIGS. 12 to 14. As illustrated in FIG. 12, a thickness detection sensor 70 includes: a reference roller 71 whose axis of rotation is fixed and which functions as the reference for thickness determination; a detection roller 72 situated above and in contact with the reference roller 71; a detection block 73, which is attached to the detection roller 72 at its one end, is fixed rotatably about a fulcrum shaft 74 at its other end, and is rotationally displaced in the direction of the arrow according to the thickness of the banknote 1 passing between the reference roller 71 and the detection roller 72; a holding block 75 configured to hold at least the fulcrum shaft 74 of the detection block 73; a metallic leaf spring 76, which is fixed on the holding block 75, partially presses the detection block 73 to keep the contact between the detection roller 72 and the reference roller 71, and is displaced by being pushed up according to the rotational displacement of the detection block 73 involved in passage of the banknote 1 between the reference roller 71 and the detection roller 72; a displacement sensor 77 configured to detect the amount of displacement of the leaf spring 76 in a contactless manner; and a signal processor (sensor substrate) 78 configured to detect the thickness of the banknote 1 based on the output signal from the displacement sensor 77.

The mechanism of the thickness detection is briefly described. When the banknote 1 is transported to between the reference roller 71 and the detection roller 72, since the axis of rotation of the reference roller 71 is fixed, the detection roller 72 is pushed up as much as the thickness of the banknote 1. The detection block 73 to which the detection roller 72 is fixed is fixed rotatably about the fulcrum shaft 74, and moves up as the detection roller 72 moves up. The leaf spring 76, which is always in contact with the detection block 73 and pushes the detection block 73 down with its elasticity, is displaced upwardly as much as the detection block 73 moves. The change in distance (d) between the leaf spring 76 and the displacement sensor 77 is output as an electric signal by the displacement sensor 77, which is detected as the thickness of the banknote 1 by the signal processor 78. Although the case where the leaf spring 76 is made of a metal is taken as an example in the above description, the leaf spring 76 is not necessarily made of a metal and may be made of a resin. In the case where the leaf spring 76 is made of a resin, the displacement sensor 77 may be a distance sensor utilizing a laser, for example.

After the banknote 1 passes between the reference roller 71 and the detection roller 72, the leaf spring 76 pushes down with its elasticity the detection block 73, bringing the reference roller 71 and the detection roller 72 in contact with each other again.

As illustrated in FIGS. 12 and 13, the thickness detection sensor 70 further includes a sheet-shaped scraper 79. The scraper 79 is fixed to the detection block 73 with screws, and is in contact with the detection roller 72 in a substantially perpendicular manner. A foreign material on the banknote 1 may adhere to the detection roller 72, but the foreign material adhering to the detection roller 72 can be removed by the scraper 79 as the detection roller 72 rotates.

The thickness detection sensor 70 includes, as illustrated in FIG. 14, compression springs 80 pressing the fulcrum shaft 74 of the detection block 73 from both sides. The compression springs 80 increase the contact and the frictional force between adjacent detection blocks 73, restricting the movements of the detection blocks 73.

Any data collected by a line sensor extending in the direction perpendicular to the transport path 15 other than the optical line sensor 20 may also be stored in the ring memory 40 as well as data collected by the optical line sensor 20. For example, thickness data collected by a thickness detection sensor extending in the direction perpendicular to the transport path 15 may be stored in the ring memory 40 and the same data process as in the case of processing the data collected by the optical line sensor 20 may be applied. In this case, the image data collected by the optical line sensor 20 and the thickness data collected by the thickness detection sensor can be completely collected without fail for the recognition process.

An embodiment of the present invention was described above. The embodiment, however, is not intended to limit the scope of the present invention. The configurations described in the embodiment may appropriately be deleted, added, modified, or combined within the spirit of the present invention. For example, the sensor unit 105 in the embodiment employs long-edge feed where the transport direction of the banknote 1 is parallel to the short edges of the banknote 1. Yet, the sensor unit 105 may employ short-edge feed where the transport direction of the banknote 1 is parallel to the long edges of the banknote 1.

### INDUSTRIAL APPLICABILITY

As described above, the present invention relates to a sheet recognition device and a sheet recognition method which enable collection of data, including images and thicknesses of sheets such as banknotes, for recognition process. These sheet recognition device and sheet recognition method are useful techniques to collect complete data used for recognition process of sheets without fail.

### REFERENCE SIGNS LIST

1: banknote
2a: clear window
3: opaque portion
12a, 12b: medium detection sensor
15: transport path
20: optical line sensor
21: image sensor
22: rod lens array
23, 27: light guide
24: measurement window
25: photodetector
26: light source for reflection
28: irradiation window
29: light source for transmission
30, 31: roller
40: ring memory
50: controller
60: recognition processor
70: thickness detection sensor
71: reference roller
72: detection roller
73: detection block
74: fulcrum shaft
75: holding block
76: leaf spring
77: displacement sensor
78: signal processor
79: scraper
80: compression spring
100: banknote handling machine
101: banknote inlet
102: banknote outlet
103: operation/display unit
105: sensor unit
R1: first data path
R2: second data path

1. A sheet recognition device configured to collect data for recognition of a sheet, the device comprising:
a transporter configured to transport the sheet;
a medium detection sensor partially disposed in a width direction of a transport path and configured to detect arrival of the transported sheet, the width direction crossing a transport direction of the sheet;
a line sensor disposed at a more downstream position of the transport path than the medium detection sensor, having a linear shape extending in the width direction of the transport path, and configured to scan at least part of the transported sheet;
a ring memory configured to sequentially store collection data collected by the line sensor and sequentially overwrite an oldest piece of stored collection data with a newest piece of collection data when the stored data volume exceeds a capacity of the ring memory;
a recognition processor configured to recognize the sheet;
a first data path through which the line sensor directly outputs the collection data to the recognition processor;
a second data path through which the line sensor outputs the collection data to the ring memory and the ring memory outputs the stored data to the recognition processor; and
a controller configured to select the first data path or the second data path upon detection of arrival of the sheet by the medium detection sensor or the line sensor,
the controller selecting the second data path upon detection of arrival of the sheet by the line sensor and causing the ring memory to output, to the recognition processor, the collection data collected by the line sensor and stored in the ring memory before the detection of arrival of the sheet.

2. The sheet recognition device according to claim 1,
wherein the controller is configured to cause the ring memory to continuously output the collection data collected by the line sensor and stored before the detection of arrival of the sheet and then the collection data collected by the line sensor after the detection of arrival of the sheet to the recognition processor through the second data path.

3. The sheet recognition device according to claim 1,
wherein the controller is configured to, upon detection of arrival of the sheet by the medium detection sensor, select the second data path and delay the time for the ring memory to start outputting collection data collected by the line sensor to after the time set for the case of detection of arrival of the sheet by the line sensor.

4. The sheet recognition device according to claim 1,
wherein the controller is configured to cause the ring memory to output the collection data collected by the line sensor and stored before the detection of arrival of the sheet to the recognition processor through the second data path, and cause the line sensor to output the collection data collected after the detection of arrival of the sheet to the recognition processor through the first data path.

5. The sheet recognition device according to claim 1,
wherein the line sensor is an optical line sensor.

6. The sheet recognition device according to claim 5,
wherein the optical line sensor comprises a light source configured to irradiate the transported sheet with light, and a photodetector configured to receive the light transmitted by the sheet, and
the controller is configured to determine whether or not a detection amount of the sheet is equal to or greater than a threshold based on a transmission image obtained by the optical line sensor.

7. The sheet recognition device according to claim 1,
wherein the line sensor is a thickness detection sensor.

8. The sheet recognition device according to claim 1,
wherein the controller is configured to determine a degree of skew of the transported sheet and change the volume of data to be output by the ring memory based on the degree of skew, the data being stored in the ring memory before the detection of arrival of the sheet.

9. A sheet recognition method used to collect data for recognition of a sheet, the method comprising:
detecting arrival of the sheet transported, using a medium detection sensor being partially disposed in a width direction of a transport path, the width direction crossing a transport direction of the sheet;
scanning at least part of the transported sheet, using a line sensor being disposed at a more downstream position of the transport path than the medium detection sensor and having a linear shape extending in the width direction of the transport path;
sequentially storing collection data collected by the line sensor in the scanning into a ring memory and sequentially overwriting an oldest piece of stored collection data with a newest piece of collection data when the stored data volume exceeds a capacity of the ring memory; and
selecting, upon detection of arrival of the sheet in the detecting or the scanning, a first data path through which the line sensor directly outputs the collection data to a recognition processor or a second data path through which the line sensor outputs the collection data to the ring memory and the ring memory outputs the stored data to the recognition processor,
the method including selecting the second data path upon detection of arrival of the sheet by the line sensor and causing the ring memory to output, to the recognition processor, the collection data collected by the line sensor and stored in the ring memory before the detection of arrival of the sheet.
